(19) United States
(12) Patent Application Publication
(10) Pub. No.: US 2025/0370362 A1
(43) Pub. Date: Dec. 4, 2025

(54) LASER SCANNING UNIT, IMAGE FORMING DEVICE AND SCANNING CONTROL METHOD

(71) Applicant: Zhuhai Pantum Electronics Co., Ltd., Zhuhai (CN)

(72) Inventors: Yongchao NIE, Zhuhai (CN); Zhiliang FU, Zhuhai (CN)

(21) Appl. No.: 19/216,948

(22) Filed: May 23, 2025

(30) Foreign Application Priority Data
May 31, 2024 (CN) 202410702452.8

(51) Int. Cl. G03G 15/01; B41J 2/447; B41J 2/47; G03G 15/04; G03G 15/043

(52) U.S. Cl. CPC G03G 15/011; B41J 2/447; B41J 2/473; G03G 15/0189; G03G 15/04036; G03G 15/0435

(57) ABSTRACT

The disclosure provides a laser scanning unit, an image forming device and a scanning control method, where the laser scanning unit includes a deflection device, an optical system, a first light source, a second light source, a line synchronization detection unit and a controller. The controller is configured to adjust a first time interval and/or a second time interval according to a change value of a third time interval. The first time interval is a time interval between a start time of a first detection signal and a first scanning start time, the second time interval is a time interval between a start time of a second detection signal and a second scanning start time, and the third time interval is a time interval between the start time of the first detection signal and the end time of the second detection signal.

### CROSS-REFERENCE TO RELATED DISCLOSURE

This application claims priority of Chinese Patent Application No. 202410702452.8 filed on May 31, 2024, the entire content of which is hereby incorporated by reference.

### TECHNICAL FIELD

This application relates to the field of image forming technology, and in particular to a laser scanning unit, an image forming device and a scanning control method.

### BACKGROUND

An image forming device is a device that forms an image on a recording medium by the imaging principle, such as a printer, a copier, a fax machine, a multifunctional image making and copying device, an electrostatic printing device, and any other similar device.

A laser scanning unit is a device widely used in image forming devices, such as laser printers. Its principle is mainly to emit laser light to irradiate the photosensitive member of a laser printer to form an electrostatic latent image on the photosensitive member, which further forms an image and is transferred to the medium.

The laser scanning unit mainly includes: a beam emitting device for emitting a beam; a deflection device for deflecting the beam emitted from the beam emitting device into an optical system; an optical system arranged between the deflection device and the photosensitive member, where each optical system uses the beam deflected by the deflection device to scan the photosensitive surface on the photosensitive member. When the beam of the laser scanning unit (LSU) is scanned onto the photosensitive member, an electrostatic latent image is formed on the photosensitive surface of the photosensitive member, and the electrostatic latent image may be converted into an actual image by using a carrier, such as a toner.

Common color laser printers have a four-color imaging system of K, C, M, and Y. The color of the image is obtained by accurately stacking the toners of these four colors. Therefore, the stacking accuracy of the KCMY four-color imaging system directly affects the quality of the image. The laser scanning unit of a color laser printer also includes four KCMY light paths. The printer controls the timing of the exposure of the laser scanning unit to make the exposure position of KCMY accurately overlap, thereby achieving high image stacking accuracy. However, the image stacking accuracy will be deteriorated by various printing environments, such as temperature, humidity, paper, etc. Therefore, the printer needs to make certain adjustments in terms of control so that the image stacking may maintain a high accuracy even when the printing environment changes.

### SUMMARY

In view of the foregoing, the present disclosure provides a laser scanning unit, an image forming device and a scanning control method.

In one aspect, an embodiment of the present disclosure provides a laser scanning unit, applied to an image forming device, the image forming device including an imaging unit for forming an image and a transfer unit for transferring the image to a recording material, the imaging unit including a first imaging cartridge and a second imaging cartridge, the first imaging cartridge having a first photosensitive member arranged perpendicularly to an image transfer direction of the transfer unit, the second imaging cartridge having a second photosensitive member arranged perpendicularly to the image transfer direction of the transfer unit, and the laser scanning unit including: a deflection device for rotating and deflecting a light beam; an optical system for transmitting the light beam deflected by the deflection device to the imaging unit; a first light source, configured to emit a first light beam, where the first light beam is rotated and deflected by the deflection device to the optical system, and then transmitted to the first photosensitive member through the optical system, and scans a surface of the first photosensitive member along a first direction as the deflection device rotates; a second light source, configured to emit a second light beam, where the second light beam is rotated and deflected by the deflection device to the optical system, and then transmitted to the second photosensitive member through the optical system, and scans a surface of the second photosensitive member along a second direction as the deflection device rotates, and the second direction is opposite to the first direction; a line synchronization detection unit, including a first photosensitive element and a second photosensitive element, where the first photosensitive element is configured to sense the first light beam rotationally deflected by the deflection device and generate a first detection signal, and the second photosensitive element is configured to sense the second light beam rotationally deflected by the deflection device and generate a second detection signal; and a controller, configured to adjust a first time interval and/or a second time interval according to a change value of a third time interval, where the change value of the third time interval is determined by a current value of the third time interval and a predefined value of the third time interval; the first time interval is an interval between a start time of the first detection signal and a first scanning start time, the second time interval is an interval between a start time of the second detection signal and a second scanning start time, and the third time interval is an interval between the start time of the first detection signal and an end time of the second detection signal; and the first light source is configured to start emitting the first light beam to scan the first photosensitive member based on the first scanning start time, and the second light source is configured to start emitting the second light beam to scan the second photosensitive member based on the second scanning start time.

In one embodiment, adjusting the first time interval and/or the second time interval according to the change value of the third time interval includes setting a first difference and a second difference based on the change value; adjusting the first time interval based on the first difference, where the adjusted first time interval is equal to a sum of a predefined value of the first time interval and the first difference; and adjusting the second time interval based on the second difference, and the adjusted second time interval is equal to a sum of a predefined value of the second time interval and the second difference.

In one embodiment, setting the first difference and the second difference based on the change value of the third time interval includes setting the first difference and the second difference based on the change value, where a sum of the first difference and the second difference is equal to the change value.

In one embodiment, adjusting the first time interval according to the change value of the third time interval includes: setting a first difference based on the change value; and adjusting the first time interval based on the first difference, where the adjusted first time interval is equal to a sum of a predefined value of the first time interval and the first difference; or adjusting the second time interval according to the change value of the third time interval includes: setting a second difference based on the change value; and adjusting the second time interval based on the second difference, where the adjusted second time interval is equal to a sum of a predefined value of the second time interval and the second difference.

In one embodiment, adjusting the first time interval and/or the second time interval according to the change value of the third time interval includes if the change value is greater than or equal to a predefined change threshold, adjusting the first time interval and/or the second time interval according to the change value of the third time interval.

In one embodiment, the controller is further configured for: after receiving the first detection signal generated by the first photosensitive element, delaying the first time interval, and then controlling the first light source to emit the first light beam to scan the first photosensitive member; and after receiving the second detection signal generated by the second photosensitive element, delaying the second time interval, and then controlling the second light source to emit the second light beam to scan the second photosensitive member.

In one embodiment, the first light source includes N first sub-light sources, each of which emits a first sub-light beam, and the imaging unit includes N first imaging cartridges, the N first sub-light beams are respectively configured to scan surfaces of first photosensitive members of the N first imaging cartridges along the first direction as the deflection device rotates, and adjustment amounts of first time intervals corresponding to the N first sub-light sources are the same, where N 2.

In one embodiment, the second light source includes M second sub-light sources, each of which emits a second sub-beam, the imaging unit includes M second imaging cartridges, the M second sub-beams are respectively configured to scan surfaces of second photosensitive members of the M second imaging cartridges along the second direction as the deflection device rotates, and adjustment amounts of second time intervals corresponding to the M second sub-light sources are the same, where M≥2.

In one embodiment, the controller is further configured for: after adjusting the first time interval and/or the second time interval according to the change value of the third time interval, updating the predefined value of the third time interval to a current value of the third time interval.

In another aspect, an embodiment of the present disclosure provides an image forming device, including a laser scanning unit, an imaging unit for forming an image, and a transfer unit for transferring the image to a recording material, the imaging unit including a first imaging cartridge and a second imaging cartridge, the first imaging cartridge having a first photosensitive member arranged perpendicularly to an image transfer direction of the transfer unit, the second imaging cartridge having a second photosensitive member arranged perpendicularly to the image transfer direction of the transfer unit, and the laser scanning unit including: a deflection device for rotating and deflecting a light beam; an optical system for transmitting the light beam deflected by the deflection device to the imaging unit; a first light source, configured to emit a first light beam, where the first light beam is rotated and deflected by the deflection device to the optical system, and then transmitted to the first photosensitive member through the optical system, and scans a surface of the first photosensitive member along a first direction as the deflection device rotates; a second light source, configured to emit a second light beam, where the second light beam is rotated and deflected by the deflection device to the optical system, and then transmitted to the second photosensitive member through the optical system, and scans a surface of the second photosensitive member along a second direction as the deflection device rotates, and the second direction is opposite to the first direction; a line synchronization detection unit, including a first photosensitive element and a second photosensitive element, where the first photosensitive element is configured to sense the first light beam rotationally deflected by the deflection device and generate a first detection signal, and the second photosensitive element is configured to sense the second light beam rotationally deflected by the deflection device and generate a second detection signal; and a controller, configured to adjust a first time interval and/or a second time interval according to a change value of a third time interval, where: the change value of the third time interval is determined by a current value of the third time interval and a predefined value of the third time interval; the first time interval is an interval between a start time of the first detection signal and a first scanning start time, the second time interval is an interval between a start time of the second detection signal and a second scanning start time, and the third time interval is an interval between the start time of the first detection signal and an end time of the second detection signal; and the first light source is configured to start emitting the first light beam to scan the first photosensitive member based on the first scanning start time, and the second light source is configured to start emitting the second light beam to scan the second photosensitive member based on the second scanning start time.

In another aspect, an embodiment of the present disclosure provides a scanning control method, applied to an image forming device, the image forming device including a laser scanning unit, an imaging unit for forming an image, and a transfer unit for transferring the image to a recording material, the imaging unit including a first imaging cartridge and a second imaging cartridge, the first imaging cartridge having a first photosensitive member arranged perpendicularly to an image transfer direction of the transfer unit, the second imaging cartridge having a second photosensitive member arranged perpendicularly to the image transfer direction of the transfer unit, and the laser scanning unit including: a deflection device for rotating and deflecting a light beam; an optical system for transmitting the light beam deflected by the deflection device to the imaging unit; a first light source, configured to emit a first light beam, where the first light beam is rotated and deflected by the deflection device to the optical system, and then transmitted to the first photosensitive member through the optical system, and scans a surface of the first photosensitive member along a first direction as the deflection device rotates; a second light source, configured to emit a second light beam, where the second light beam is rotated and deflected by the deflection device to the optical system, and then transmitted to the second photosensitive member through the optical system, and scans a surface of the second photosensitive member along a second direction as the deflection device rotates, and the second direction is opposite to the first direction; and a line synchronization detection unit, including a first photosensitive element and a second photosensitive element, where the first photosensitive element is configured to sense the first light beam rotationally deflected by the deflection device and generate a first detection signal, and the second photosensitive element is configured to sense the second light beam rotationally deflected by the deflection device and generate a second detection signal, where the scanning control method includes: obtaining a current value of a third time interval between a start time of the first detection signal and an end time of the second detection signal; calculating a change value generated by the third time interval based on a predefined value of the third time interval; and adjusting a first time interval between a first scanning start time and a start time of the first detection signal and/or adjusting a second time interval between a second scanning start time and a start time of the second detection signal according to the change value, where the first light source is configured to start emitting the first light beam to scan the first photosensitive member based on the first scanning start time, and the second light source is configured to start emitting the second light beam to scan the second photosensitive member based on the second scanning start time.

In one embodiment, adjusting the first time interval and/or the second time interval according to the change value of the third time interval includes: setting a first difference and a second difference based on the change value; adjusting the first time interval based on the first difference, where the adjusted first time interval is equal to a sum of a predefined value of the first time interval and the first difference; and adjusting the second time interval based on the second difference, and the adjusted second time interval is equal to a sum of a predefined value of the second time interval and the second difference.

In one embodiment, setting the first difference and the second difference based on the change value of the third time interval includes: setting the first difference and the second difference based on the change value, where a sum of the first difference and the second difference is equal to the change value.

In one embodiment, adjusting the first time interval according to the change value of the third time interval includes: setting a first difference based on the change value; and adjusting the first time interval based on the first difference, where the adjusted first time interval is equal to a sum of a predefined value of the first time interval and the first difference; or adjusting the second time interval according to the change value of the third time interval includes: setting a second difference based on the change value; and adjusting the second time interval based on the second difference, where the adjusted second time interval is equal to a sum of a predefined value of the second time interval and the second difference.

In one embodiment, adjusting the first time interval and/or the second time interval according to the change value of the third time interval includes: if the change value is greater than or equal to a predefined change threshold, adjusting the first time interval and/or the second time interval according to the change value of the third time interval.

In one embodiment, the control method further includes: after receiving the first detection signal generated by the first photosensitive element, delaying the first time interval, and then controlling the first light source to emit the first light beam to scan the first photosensitive member; and after receiving the second detection signal generated by the second photosensitive element, delaying the second time interval, and then controlling the second light source to emit the second light beam to scan the second photosensitive member.

In one embodiment, the first light source includes N first sub-light sources, each of which emits a first sub-light beam, and the imaging unit includes N first imaging cartridges, the N first sub-light beams are respectively configured to scan surfaces of first photosensitive members of the N first imaging cartridges along the first direction as the deflection device rotates, where N≥2; and adjusting the first time interval and/or the second time interval according to the change value of the third time interval includes: simultaneously adjusting first time intervals corresponding to the N first sub-light sources based on a same adjustment amount.

In one embodiment, the second light source includes M second sub-light sources, each of which emits a second sub-light beam, the imaging unit includes M second imaging cartridges, and the M second sub-light beams are respectively configured to scan surfaces of second photosensitive members of the M second imaging cartridges along the second direction as the deflection device rotates, where M≥2; and adjusting the first time interval and/or the second time interval according to the change value of the third time interval includes: simultaneously adjusting second time intervals corresponding to the M second sub-light sources based on a same adjustment amount.

In one embodiment, the method further includes: after adjusting the first time interval and/or the second time interval according to the change value of the third time interval, updating the predefined value of the third time interval to a current value of the third time interval.

In another aspect, an embodiment of the present disclosure provides an electronic device, including: at least one processor; and at least one memory in communication with the processor, where the memory stores program instructions that may be executed by the processor, and the processor calls the program instructions to execute any of the above described methods.

In another aspect, an embodiment of the present disclosure provides a computer-readable storage medium having a computer program stored thereon. When the computer program is executed by a processor, any of the above described methods is implemented.

Other features of the present disclosure and advantages thereof will become apparent from the following detailed description of exemplary embodiments of the present disclosure with reference to the accompanying drawings.

### BRIEF DESCRIPTION OF THE DRAWINGS

In order to more clearly illustrate the technical solutions of the embodiments of the present disclosure, the drawings essential for understanding the embodiments will be briefly introduced below. Apparently, the drawings described below are merely some embodiments of the present disclosure. For a person skilled in the art, other drawings may be obtained based on these drawings without making creative efforts.

FIG. 1 is a schematic structural diagram of an image forming device, in accordance with an embodiment of the present disclosure;

FIG. 2 is a schematic diagram of a planar expansion of an optical path layout of a laser scanning unit in a main scanning direction, in accordance with an embodiment of the present disclosure;

FIG. 3 is a schematic diagram of another planar expansion of an optical path layout of a laser scanning unit in a main scanning direction, in accordance with an embodiment of the present disclosure;

FIG. 4 is a cross-sectional schematic diagram of an optical path layout of a laser scanning unit in a sub-scanning direction, in accordance with an embodiment of the present disclosure;

FIG. 5 is a schematic diagram of a light source layout distribution, in accordance with an embodiment of the present disclosure;

FIG. 6 is a schematic diagram of an exposure control timing of a laser scanning unit, in accordance with an embodiment of the present disclosure;

FIG. 7 is a schematic diagram of corresponding light spot positions when a synchronous signal is generated in an initial optical power state and an increased optical power state, in accordance with an embodiment of the present disclosure;

FIG. 8 is a schematic diagram of an exposure control timing of a laser scanning unit after a light power increase, in accordance with an embodiment of the present disclosure;

FIG. 9 is a schematic diagram of position changes of images generated in an initial optical power state and an increased optical power state, in accordance with an embodiment of the present disclosure;

FIG. 10 is a flow chart of a scanning control method, in accordance with an embodiment of the present disclosure;

FIG. 11 is a flow chart of another scanning control method, in accordance with an embodiment of the present disclosure;

FIG. 12 is a schematic structural diagram of an image forming device, in accordance with an embodiment of the present disclosure; and

FIG. 13 is a schematic structural diagram of an electronic device, in accordance with an embodiment of the present disclosure.

### DETAILED DESCRIPTION

In order to better understand the technical solutions of the present disclosure, the embodiments of the present disclosure are described in detail hereinafter with reference to the accompanying drawings.

It should be understood that the described embodiments are merely some of the embodiments of the present disclosure, rather than all the embodiments. Based on the embodiments in the present disclosure, all other embodiments obtained by a person skilled in the art without making creative efforts are within the scope of protection of the present disclosure.

The terms used in the embodiments of the present disclosure are merely for the purpose of describing specific embodiments, and are not intended to limit the present disclosure. The singular forms “a”, “said” and “the” used in the embodiments of the present disclosure and the appended claims are also intended to include plural forms, unless the context clearly indicates other meanings.

It should be understood that the term “and/or” used in this disclosure is merely a description of the association relationship of associated objects, indicating that there may be three relationships. For example, A and/or B may represent: A exists alone, A and B exist at the same time, and B exists alone. In addition, the character “/” in the present disclosure generally indicates that the associated objects before and after are in an “or” relationship.

For ease of explanation, the embodiments of the present disclosure define an x-axis direction, a y-axis direction, and a z-axis direction on the image forming device, where the x-axis direction is a direction parallel to the image transfer direction of a transfer unit, the y-axis direction is a direction parallel to the rotation axis of a deflection device, and the z-axis direction is a direction parallel to the axis of a photosensitive member, e.g., a photosensitive drum.

A laser scanning unit is a device widely used in image forming devices, such as laser printers. Its principle is mainly to emit laser light to irradiate the photosensitive member of a laser printer to form an electrostatic latent image on the photosensitive member, which further forms an image and is transferred to the medium.

The laser scanning unit mainly includes: a beam emitting device for emitting a beam; a deflection device for deflecting the beam emitted from the beam emitting device into an optical system; an optical system arranged between the deflection device and a photosensitive member, where each optical system uses the beam deflected by the deflection device to scan the photosensitive surface on the photosensitive member. When the beam of the laser scanning unit (LSU) is scanned onto the photosensitive member, an electrostatic latent image is formed on the photosensitive surface of the photosensitive member, and the electrostatic latent image may be converted into an actual image by using a carrier, such as a toner.

Common color laser printers have a four-color imaging system of K, C, M, and Y. The color of the image is obtained by accurately stacking the toners of these four colors. Therefore, the stacking accuracy of the KCMY four-color imaging system directly affects the quality of the image. The laser scanning unit of a color laser printer also includes four KCMY light paths. The printer controls the timing of the exposure of the laser scanning unit to make the exposure position of KCMY accurately overlap, thereby achieving high image stacking accuracy. However, the image stacking accuracy will be deteriorated by various printing environments, such as temperature, humidity, paper, etc. Therefore, the printer needs to make certain adjustments in terms of control so that the image stacking may maintain a high accuracy even when the printing environment changes.

In response to the above problems, embodiments of the present disclosure provide a laser scanning unit, an image forming device, a scanning control method, an electronic device and a computer storage medium. The present disclosure may ensure the accuracy of image color overlay when the image forming environment changes by adjusting the interval time between the start time of the first detection signal and the start time of the first scan and/or the interval time between the start time of the second detection signal and the start time of the second scan.

The following is a detailed description with reference to the accompanying drawings.

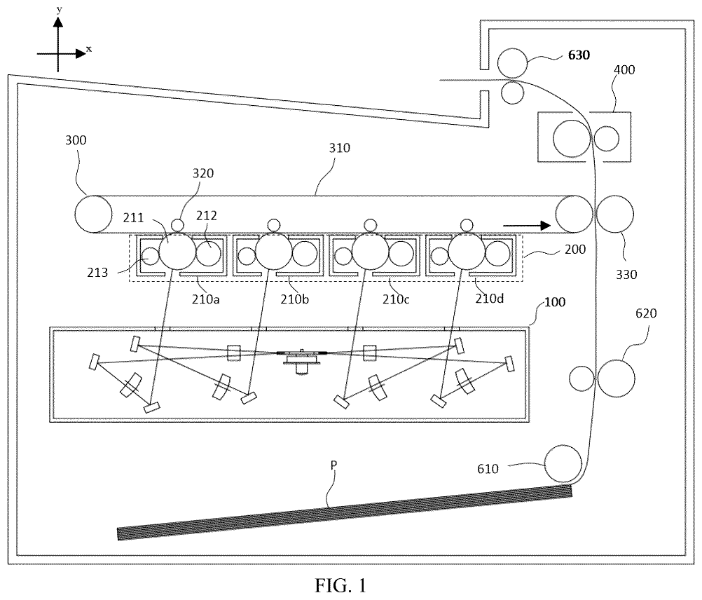

FIG. 1 is a schematic structural diagram of an image forming device, in accordance with an embodiment of the present disclosure is shown. FIG. 1 mainly shows the part where a toner image is transferred to the recording medium. The image forming device is a color image forming device, including a laser scanning unit 100, an imaging unit 200, a transfer unit 300 and a fixing unit 400, where the imaging unit 200 includes at least one first imaging cartridge and at least one second imaging cartridge, each of which is provided with a first photosensitive member arranged perpendicularly to the image transfer direction of the transfer unit 300, and each of which is provided with a second photosensitive member arranged perpendicularly to the image transfer direction of the transfer unit 300. The image transfer direction of the transfer unit 300 is shown by the black arrow in FIG. 1, which points from the negative direction of the x-axis to the positive direction of the x-axis. Correspondingly, the first photosensitive member and the second photosensitive member are arranged along the z-axis direction.

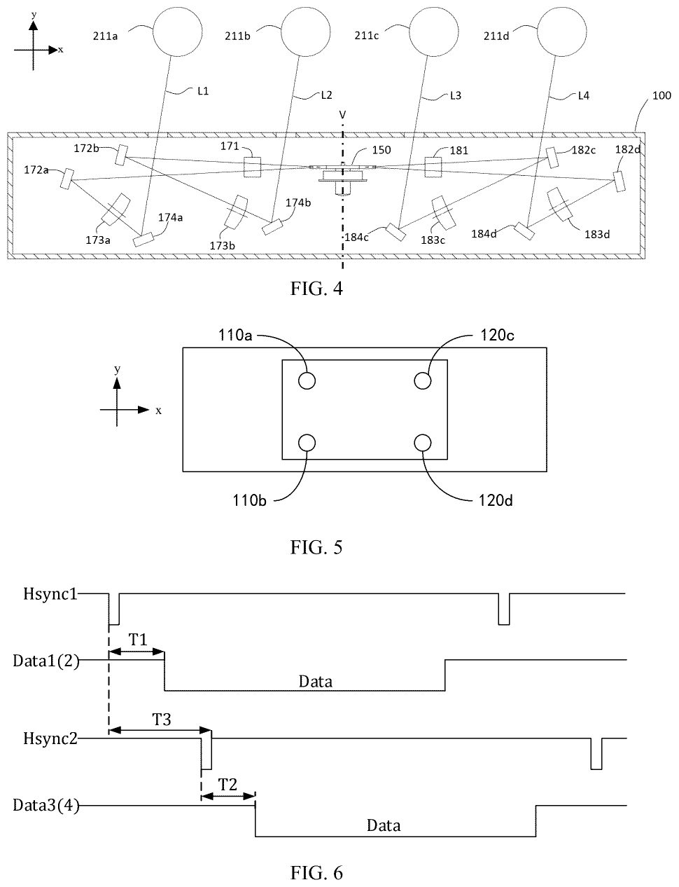

In one embodiment, since the color image forming device generally includes a four-color imaging system of black (K), magenta (M), cyan (C) and yellow (Y), two first imaging cartridges and two second imaging cartridges may be provided accordingly. As shown in FIGS. 1 and 4, the two first imaging cartridges include a first imaging cartridge 210a and a first imaging cartridge 210b, where the first imaging cartridge 210a is provided with a first photosensitive member 211a for forming a black (K) toner image, and the first imaging cartridge 210b is provided with a first photosensitive member 211b for forming a magenta (M) toner image. The two second imaging cartridges include a second imaging cartridge 210c and a second imaging cartridge 210d, where the second imaging cartridge 210c is provided with a second photosensitive member 211c for forming a cyan (C) toner image, and the second imaging cartridge 210d is provided with a second photosensitive member 211d for forming a yellow (Y) toner image.

In the embodiments of the present disclosure, since the basic component structures of the first imaging cartridge and the second imaging cartridge are the same, when introducing the structures of the first imaging cartridge and the second imaging cartridge hereinafter, the first imaging cartridge and the second imaging cartridge may be collectively referred to as imaging cartridges, and correspondingly, the first photosensitive member and the second photosensitive member may be collectively referred to as photosensitive members.

As shown in FIG. 1, during the laser imaging process, the laser scanning unit 100 is configured to emit a plurality of laser beams, each laser beam correspondingly scans an imaging cartridge. Each imaging cartridge is provided with a photosensitive member 211, a developing assembly 212 and a charging roller 213, where the photosensitive member 211 is configured to receive the laser beam and form an electrostatic latent image on the surface of the photosensitive member 211 based on the scanning of the laser beam. The developing assembly 212 is configured to attach carbon powder to the surface of the photosensitive member 211 so as to convert the electrostatic latent image into a toner image through the carbon powder. The charging roller 213 is arranged at a position tangent to the photosensitive member 211 and is configured to charge the surface of the photosensitive member 211 so as to maintain the potential difference of the photosensitive member 211. The transfer unit 300 includes a transfer belt 310, a first transfer roller 320 and a second transfer roller 330, where the first transfer roller 320 is configured to transfer the toner image on the surface of the photosensitive member 211 to the transfer belt 310, and the second transfer roller 330 is configured to transfer the toner image on the transfer belt 310 to the recording medium P. The toner image on the recording medium P is heated and fixed by the fixing unit 400. In the disclosed embodiment, the image transfer direction of the transfer unit 300 may be regarded as the image transfer direction of the transfer belt 310.

In the embodiments of the present disclosure, upon receiving an image forming job instruction, the image forming device sends an image signal of each color to the laser scanning unit 100, and the laser scanning unit 100 scans each photosensitive member 211 based on the image signal to form an electrostatic latent image of a different color on each photosensitive member 211. The electrostatic latent image formed on each photosensitive member 211 is developed by a respective developing assembly 212 to form a toner image of a different color on each photosensitive member 211. As the transfer belt 310 rotates, the toner images are sequentially transferred to the transfer belt 310 so as to overlap with each other. Subsequently, the recording medium P is conveyed by the paper feed roller 610 to the paper transport roller 620, and then conveyed by the paper transport roller 620 to the second transfer roller 330. At this moment, the colorant image formed on the transfer belt 310 is transferred to the recording medium P through the second transfer roller 330, and then the recording medium P is conveyed to the fixing unit 400 for heating and fixing, and finally discharged by the paper discharge roller 630.

It should be noted that the recording medium involved in the embodiments of the present disclosure refers to a carrier for carrying image forming content. For example, the recording medium may be paper. Apparently, in addition to paper, the recording medium may also be a carrier of other materials, which is not limited in the embodiments of the present disclosure.

It should be noted that FIG. 1 is merely an exemplary description and should not be considered as a limitation on the protection scope of the present disclosure. For example, the image transfer direction of the transfer unit may be set to a direction opposite to the arrow shown in the figure, the number of the first imaging cartridges and the second imaging cartridges may be set to one respectively, the colors of the toner images formed by the first imaging cartridges and the second imaging cartridges may be changed according to the needs, etc.

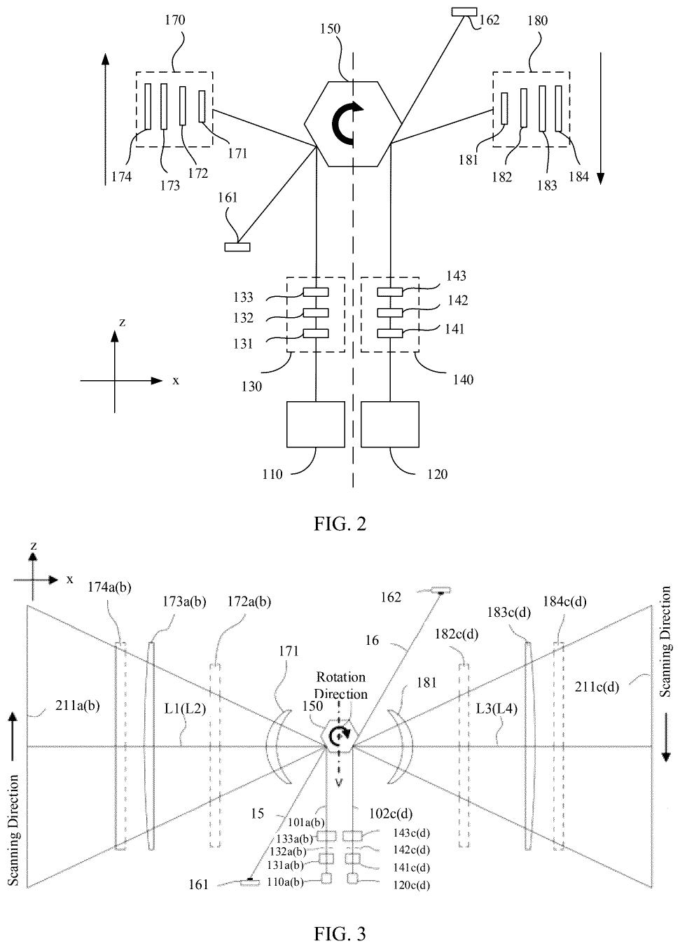

FIG. 2 is a schematic diagram of a plane expansion of an optical path layout of a laser scanning unit in a main scanning direction, in accordance with an embodiment of the present disclosure, where the main scanning direction is a direction parallel to the photosensitive surface of a photosensitive member 211, that is, the z-axis direction. As shown in FIG. 2, the laser scanning unit 100 includes a deflection device, an optical system, a plurality of light sources, a line synchronization detection unit and a controller (not shown in the figure).

The deflection device 150 is configured to rotate and deflect a light beam. Specifically, the deflection device 150 is a polygonal column structure, and the axis is arranged along the y-axis direction. At the same time, each side surface of the deflection device 150 around the y-axis is a reflection surface, and each reflection surface is configured to reflect a received light beam, thereby realizing the rotational deflection of the light beam. In the disclosed embodiment, the deflection device is a hexagonal prism. Apparently, the deflection device may also be a triangular prism, a quadrangular prism, etc. In one embodiment, a rotary motor may be provided to control the rotation of the deflection device 150, so that the reflection surface of the deflection device 150 reflects the received light beam along a configured direction as the deflection device 150 rotates.

The optical system includes an incident optical system and a scanning optical system, where the incident optical system is arranged between the multiple light sources and the deflection device 150, and is configured to collimate the light beams emitted by the multiple light sources and focus them onto the reflection surface of the deflection device 150. The scanning optical system is arranged on two opposite sides of the deflection device 150, and is configured to transmit the light beams deflected from the deflection device 150 to the imaging unit.

The plurality of light sources are configured to emit light beams. Specifically, the plurality of light sources may include a first light source 110 and a second light source 120. The first light source 110 is configured to emit a first light beam. After the first light beam is collimated and focused on the reflective surface of the deflection device 150 by the incident optical system, the first light beam is deflected to the scanning optical system by the deflection device 150, and then is transmitted to the first photosensitive member of the first imaging cartridge through the scanning optical system, and scans the surface of the first photosensitive member along the first direction as the deflection device 150 rotates. The second light source 120 is configured to emit a second light beam. After the second light beam is collimated and focused on the reflective surface of the deflection device 150 by the incident optical system, the second light beam is deflected to the scanning optical system by the deflection device 150, and then is transmitted to the second photosensitive member of the second imaging cartridge through the scanning optical system, and scans the surface of the second photosensitive member along the second direction as the deflection device 150 rotates. The first direction is opposite to the second direction.

Taking the embodiment shown in FIG. 3 as an example, the first imaging cartridge and the second imaging cartridge are respectively located on two opposite sides of the deflection device 150. The first light beam emitted by the first light source 110 is deflected by the deflection device 150 and then scans the surface of the first photosensitive member along the first direction (the scanning direction shown on the left side of FIG. 3), i.e., along the positive direction of the Z axis. The second light beam emitted by the second light source 120 is deflected by the deflection device 150 and then scans the surface of the first photosensitive member along the second direction (the scanning direction shown on the right side of FIG. 3), i.e., along the negative direction of the Z axis. When the start point of the scanning area of the first photosensitive member and the end point of the scanning area of the second photosensitive member and the end point of the scanning area of the first photosensitive member and the start point of the scanning area of the second photosensitive member are respectively on the same image transfer path on the transfer belt, the corresponding transferred image may be transferred to the corresponding area on the transfer belt, which may ensure that the formed image on the first photosensitive member and the formed image on the second photosensitive member will not produce color overlap deviation in the width direction of the transfer belt, i.e., the Z axis direction, thereby ensuring the color overlap accuracy.

The line synchronization detection unit includes a first photosensitive element 161 and a second photosensitive element 162. The first photosensitive element 161 is configured to sense the first light beam rotationally deflected by the deflection device 150 and generate a first detection signal, and the second photosensitive element 162 is configured to sense the second light beam rotationally deflected by the deflection device 150 and generate a second detection signal. Based on the first detection signal and the second detection signal, the positions of the first light beam and the second light beam at this point may be respectively confirmed, so as to respectively determine the first scanning start time and the second scanning start time corresponding to the first light beam and the second light beam start to scan the first photosensitive member and the second photosensitive member respectively.

The controller is configured to adjust a first time interval and/or a second time interval according to the change value of a third time interval, where the change value of the third time interval is determined by the current value of the third time interval and a predefined value of the third time interval. The first time interval is a time interval between the start time of the first detection signal and the start time of the first scan, the second time interval is a time interval between the start time of the second detection signal and the start time of the second scan, and the third time interval is a time interval between the start time of the first detection signal and the end time of the second detection signal.

In one embodiment, the first light source 110 is further configured to start emitting a first light beam based on the first scanning start time to scan the first photosensitive member, and the second light source 120 is further configured to start emitting a second light beam based on the second scanning start time to scan the second photosensitive member. The first light source is configured to start emitting a first light beam based on the first scanning start time to scan the first photosensitive member, which means that the first light source scans the first photosensitive member by emitting the first light beam. The second light source is configured to start emitting a second light beam based on the second scanning start time to scan the second photosensitive member, which means that the second light source scans the second photosensitive member by emitting the second light beam. Taking the present embodiment as an example, when the deflection device 150 rotates to one of its deflection positions, at this position, if the first light source 110 emits a first light beam, the first light beam is located at the scanning start point of the first photosensitive member after being deflected by the deflection device, and subsequently, as the deflection device 150 continues to rotate, it will sweep across the surface of the first photosensitive member along the first direction. At this point, the moment when the deflection device 150 is at this deflection position is the first scanning start time. Similarly, when the deflection device 150 rotates to a certain deflection position, at this position, if the second light source 120 emits a second light beam, the light beam is located at the scanning start point of the second photosensitive member after being deflected by the deflection device, and subsequently, as the deflection device 150 continues to rotate, it will sweep across the scanning start point of the second photosensitive member along the second direction. At this point, the moment when the deflection device 150 is at this deflection position is the second scanning start time.

The various structures in the laser scanning unit 100 along the propagation path of the light beam in the laser scanning unit 100 are further described in detail in conjunction with the accompanying drawings.

As shown in FIG. 2, the first light source 110 and the second light source 120 may be disposed on two opposite sides of the deflection device 150, respectively, and arranged in an axisymmetric manner with the center line of the deflection device 150 as an axis.

In one embodiment, according to the requirements of various color imaging systems of the image forming device, the first light source 110 may include N first sub-light sources, respectively configured to emit N first sub-beams. Each first sub-beam correspondingly scans the surface of a first photosensitive member, and N≥2. The second light source 120 may include M second sub-light sources, respectively configured to emit M second sub-beams, where each second sub-beam correspondingly scans the surface of a second photosensitive member, and M≥2. Exemplarily, as shown in FIG. 3, the first light source 110 may include first sub-light sources 110a and 110b, respectively configured to emit first sub-beams 101a and 101b, where the first sub-beam 101a correspondingly scans the surface of the first photosensitive member 211a, and the first sub-beam 101b correspondingly scans the surface of the first photosensitive member 211b. The second light source may include second sub-light sources 120c and 120d, respectively configured to emit second sub-beams 102c and 102d, where the second sub-beam 102c correspondingly scans the surface of the second photosensitive member 211c, and the second sub-beam 102d correspondingly scans the surface of the second photosensitive member 211d.

As shown in FIG. 2, the incident optical system includes a first incident optical subsystem 130 and a second incident optical subsystem 140. The first incident optical subsystem 130 and the second incident optical subsystem 140 are respectively arranged on two opposite sides of the deflection device 150, and are arranged axially symmetrically with the center line of the deflection device 150 as the axis. Specifically, the first incident optical subsystem 130 includes a first collimating lens 131 for collimating the first light beam, a first aperture 132 for shaping the collimated first light beam, and a first cylindrical lens 133 for focusing the shaped first light beam. The second incident optical subsystem 140 includes a second collimating lens 141 for collimating the second light beam, a second aperture 142 for shaping the collimated second light beam, and a second cylindrical lens 143 for focusing the shaped second light beam.

In one embodiment, the first collimating lens 131, the first aperture 132, and the first cylindrical lens 133 may be provided with N numbers, respectively, to correspond to N different first sub-beams. The second collimating lens 141, the second aperture 142, and the second cylindrical lens 143 may be provided with M numbers, respectively, to correspond to M different second sub-beams. Exemplarily, as shown in FIG. 3, based on the first sub-beams 101a and 101b, the first collimating lenses 131a and 131b, the first apertures 132a and 132b, and the first cylindrical lenses 133a and 133b are provided. Based on the second sub-beams 102c and 102d, the second collimating lenses 141c and 141d, the second apertures 142c and 142d, and the second cylindrical lenses 143c and 143d are provided.

In the embodiments of the present disclosure, the first sub-beams 101a and 101b, and the second sub-beams 102c and 102d are collimated by the corresponding first collimating lenses 131a and 131b, and the second collimating lenses 141c and 141d, respectively. After being shaped by the first apertures 132a and 132b, and the second apertures 142c and 142d, the shaped sub-beams are focused onto the reflecting surface of the deflection device 150 by the corresponding first cylindrical lenses 133a and 133b, and the second cylindrical lenses 143c and 143d, respectively. Then, the deflection device 150 is rotated and the sub-beams are deflected to the corresponding scanning optical systems.

As shown in FIG. 2, the scanning optical system includes a first scanning optical subsystem 170 and a second scanning optical subsystem 180 which are respectively arranged on two opposite sides of the deflection device 150 and are axis-symmetrically arranged with the center line of the deflection device 150 as the axis. The first scanning optical subsystem 170 is configured to transfer the first light beam rotationally deflected by the deflection device 150 to the first photosensitive member, and make the first light beam scan the surface of the first photosensitive member along the first direction as the deflection device 150 rotates. The second optical subsystem 180 is configured to transfer the second light beam rotationally deflected by the deflection device 150 to the second photosensitive member, and make the second light beam scan the surface of the second photosensitive member along the second direction as the deflection device 150 rotates. The first direction and the second direction are opposite. Specifically, the first scanning optical subsystem 170 includes a first scanning lens 171, a first reflecting mirror 172, a third scanning lens 173 and a third reflecting mirror 174. The second optical subsystem 180 includes a second scanning lens 181, a second reflecting mirror 182, a fourth scanning lens 183 and a fourth reflecting mirror 184. After the first light beam is rotationally deflected by the deflection device 150, the first light beam is focused by the first scanning lens 171, deflected by the first reflecting mirror 172, focused by the third scanning lens 173, and deflected by the third reflecting mirror 174. Then, the first light beam is transmitted to the first photosensitive member and scans the surface of the first photosensitive member along the first direction as the deflection device 150 rotates. After the second light beam is rotationally deflected by the deflection device 150, the second light beam is focused by the second scanning lens 181, deflected by the second reflecting mirror 182, focused by the fourth scanning lens 183, and deflected by the fourth reflecting mirror 184. Then, the second light beam is transmitted to the second photosensitive member and scans the surface of the second photosensitive member along the second direction as the deflection device 150 rotates.

In one embodiment, N first scanning optical subsystems may be provided, respectively configured to transfer N rotationally deflected first sub-beams to N first photosensitive members. As the deflection device 150 rotates, the N first sub-beams scan the surfaces of the N first photosensitive members along the first direction. M second scanning optical subsystems may also be provided, respectively configured to transfer M rotationally deflected second sub-beams to M second photosensitive members. As the deflection device 150 rotates, the M second sub-beams scan the surfaces of the M second photosensitive members along the second direction. In one embodiment, in order to save layout space, the N first scanning optical subsystems may share one first scanning lens, and the M second scanning optical subsystems may share one second scanning lens. Exemplarily, as shown in FIGS. 3 and 4, two first scanning optical subsystems may be provided, corresponding to the two rotationally deflected first sub-beams, respectively. For example, one first scanning optical subsystem includes a first scanning lens 171, a first reflecting mirror 172a, a third scanning lens 173a, and a third reflecting mirror 174a, and is configured to transmit the light beam L1 (the light beam after the first sub-beam 101a is deflected) to the first photosensitive member 211a. As the deflection device 150 rotates, the light beam L1 is made to scan the surface of the first photosensitive member 211a along the first direction. The other first scanning optical subsystem includes a first scanning lens 171 (in the disclosed embodiment, the two first scanning optical subsystems share the first scanning lens 171), a first reflecting mirror 172b, a third scanning lens 173b, and a third reflecting mirror 174b, and is configured to transmit the light beam L2 (the light beam after the first sub-beam 101b is deflected) to the first photosensitive member 211b. As the deflection device 150 rotates, the light beam L2 scans the surface of the first photosensitive member 211b along the first direction. Two second scanning optical subsystems may also be provided, corresponding to the two deflected second sub-beams respectively. For example, one second scanning optical subsystem includes a second scanning lens 181, a second reflecting mirror 182c, a fourth scanning lens 183c and a fourth reflecting mirror 184c, and is configured to transmit the light beam L3 (the light beam after the second sub-beam 102c is deflected) to the second photosensitive member 211c. As the deflection device 150 rotates, the light beam L3 scans the surface of the second photosensitive member 211c along the second direction. The other second scanning optical subsystem includes a second scanning lens 181 (in the disclosed embodiment, the two second scanning optical subsystems share the second scanning lens 181), a second reflecting mirror 182d, a fourth scanning lens 183d and a fourth reflecting mirror 184d, and is configured to transmit the light beam L4 (the light beam after the second sub-beam 102d is deflected) to the second photosensitive member 211d. As the deflection device 150 rotates, the light beam L4 scans the surface of the second photosensitive member 211d along the second direction. In one embodiment, the layout of the two first scanning optical subsystems and the two second scanning optical subsystems may also refer to the cross-sectional schematic diagram of the optical path layout of the laser scanning unit in the sub-scanning direction, as shown in FIG. 4, where the sub-scanning direction is a direction perpendicular to the axis of the photosensitive assembly (for example, one of the photosensitive members 211a-211d), that is, located in the common plane of the x-axis and the y-axis.

In the embodiments of the present disclosure, since the light source and each system are symmetrically distributed on two opposite sides of the deflection device 150, the beam distribution result shown in FIG. 3 may be obtained. That is, with the center line of the deflection device 150 as a reference, the first sub-beam 101a and its deflected beam L1 and the second sub-beam 101b and its deflected beam L2 are on the same side, and the second sub-beam 102c and its deflected beam L3 and the second sub-beam 102d and its deflected beam L4 are on the other side. The beam L1 correspondingly irradiates the first photosensitive member 211a to form a black electrostatic latent image, the beam L2 correspondingly irradiates the first photosensitive member 211b to form a magenta electrostatic latent image, the beam L3 correspondingly irradiates the second photosensitive member 211c to form a cyan electrostatic latent image, and the beam L4 correspondingly irradiates the second photosensitive member 211d to form a yellow electrostatic latent image.

It should be understood that the first direction and the second direction in the embodiments of the present disclosure are directions parallel to the axis of the photosensitive member, that is, the z-axis direction. Therefore, the first direction and the second direction are opposite to each other, which means that one scans from the negative pole of the z-axis to the positive pole of the z-axis along the z-axis direction, and the other scans from the positive pole of the z-axis to the negative pole of the z-axis along the z-axis direction, as shown in FIG. 3.

It should be noted that 131a(b) in FIG. 3 indicates a first collimator lens 131a and a first collimator lens 131b, and this interpretation is also applicable to 141c(d) and L1(L2) and other numbers labelled in a same manner.

As shown in FIG. 2, the first photosensitive element 161 and the second photosensitive element 162 are respectively arranged on two opposite sides of the deflection device 150, and are centrally symmetrically distributed with the deflection device 150 as the center. In practical applications, the first photosensitive element 161 is a photosensitive element configured to sense the first light beam emitted by the first light source and generate a first detection signal during the rotation of the deflection device 150, and the second photosensitive element 162 is a photosensitive element configured to sense the second light beam emitted by the second light source and generate a second detection signal during the rotation of the deflection device 150.

In one embodiment, when the first light source includes N first sub-light sources, the first photosensitive element 161 may generate a first detection signal based on the received first sub-beams of the N first sub-light sources that are rotated and deflected. When the second light source includes M second sub-light sources, the second photosensitive element 162 may generate a second detection signal based on the received second sub-beams of the M second sub-light sources that are rotated and deflected. Exemplarily, as shown in FIG. 3, the first sub-beams 101a and 101b emitted by the two first sub-light sources are rotated and deflected by the deflection device 150 and overlap into a beam L5 in the y-axis direction. The first photosensitive element 161 may generate a first detection signal based on the received beam L5. The second sub-beams 102c and 102d emitted by the two second sub-light sources are rotated and deflected by the deflection device 150 and overlap into a beam L6 in the y-axis direction, and the second photosensitive element 162 may generate a second detection signal based on the received beam L6.

In the embodiments of the disclosure, the controller is configured to delay the first time interval after receiving the first detection signal, and then control the first light source to emit the first light beam to start scanning the surface of the first photosensitive member. Here, the moment when the first light beam is deflected by the deflection device and starts to scan the surface of the first photosensitive member is the first scanning start time, and the scanning point corresponding to the first scanning start time is the scanning start point of the first light beam on the first photosensitive member. The first scanning start time may also be called the first exposure start time. The controller is also configured to delay the second time interval after receiving the second detection signal, and then control the second light beam to start scanning the surface of the second photosensitive member. Here, the moment when the second light beam is deflected by the deflection device and starts to scan the surface of the second photosensitive member is the second scanning start time, and the scanning point corresponding to the second scanning start time is the scanning start point of the second light beam on the second photosensitive member. The second scanning start time may also be called the second exposure start time. Specifically, since the first light source and the second light source in the disclosed embodiments respectively emit the first light beam and the second light beam toward the deflection device in a fixed direction, the scanning positions of the first light beam and the second light beam are related to the deflection position of the deflection device. Taking the first light beam emitted by the first light source as an example, when the first light beam deflects toward the deflection device, the deflection device rotates in a clockwise direction, and the first light beam is first reflected to the first photosensitive element and sensed by the first photosensitive element. Since the rotation speed of the deflection device is fixed, the speed of the first light beam being deflected by the deflection device for one cycle is determined. The time when the first light beam leaves the photosensitive element and arrives at the scanning start point of the first photosensitive member when the first light source continues to emit the first light beam may be calculated, and this time is the first scanning start time. Based on the first scanning start time, the first light source may emit the first light beam to scan the surface of the first photosensitive member at subsequent corresponding time points according to the image data to be formed, thereby forming electrostatic pixels on the corresponding row on the surface of the first photosensitive member. Similarly, the second scanning start time based on which the second light source starts to scan the second photosensitive member is also determined in this way, which will not be repeated here.

In one embodiment, the first time interval and the second time interval may be predefined and stored in the image forming device. When the controller receives the first detection signal and the second detection signal, the corresponding first time interval and second time interval may be directly called.

It should be noted that in the embodiments of the present disclosure, the start time of the first detection signal is the pulse start time of the first detection signal, and the pulse start time of the first detection signal is the pulse falling time of the first detection signal. That is, the controller delays the first time interval after receiving the first detection signal, which means that when the controller receives the pulse falling edge of the first detection signal, the time corresponding to the pulse falling edge is used as the timing of the start point to delay the first time interval. Similarly, the start time of the second detection signal is the pulse start time of the second detection signal, and the pulse start time of the second detection signal is the pulse falling time of the second detection signal. That is, the controller delays the second time interval after receiving the second detection signal, which means that when the controller receives the pulse falling edge of the second detection signal, the time corresponding to the pulse falling edge is used as the timing of the start point to delay the second time interval. Apparently, if the pulse start time of the first detection signal is the pulse rising time of the first detection signal and the pulse start time of the second detection signal is the pulse rising time of the second detection signal, the above process may be similarly implemented, which is not limited in the present disclosure.

In one embodiment, if the first light source includes N first sub-light sources, the controller may control the N first sub-light sources to emit first sub-light beams to scan the surfaces of the N first photosensitive members respectively. If the second light source includes M second sub-light sources, the controller may control the M second sub-light sources to emit second sub-light beams to scan the surfaces of the M second photosensitive members respectively. At this moment, the first time intervals corresponding to the N first sub-light sources are the same, that is, the controller may synchronously control the timing of the N first sub-light sources based on the same first time interval. The second time intervals corresponding to the M second sub-light sources are the same, that is, the controller may synchronously control the timing of the M second sub-light sources based on the same second time interval. It may be expanded that, due to different positions and installation errors, the first time intervals corresponding to each first sub-light source after the first detection signal may be set to different first time intervals according to the actual application situation, so as to ensure that the scanning start point of the first photosensitive member at the first scanning start time is aligned in the image transfer direction. Similarly, the second time intervals corresponding to each second sub-light source after the second detection signal may be set to different second time intervals according to the actual application situation, so as to ensure that the scanning start point of the second photosensitive member at the second scanning start time is aligned in the image transfer direction.

In one embodiment, as shown in FIGS. 3 and 5, the first sub-light source 110a and the first sub-light source 110b are located on the same side and share a first photosensitive element 161, and the second sub-light source 120c and the second sub-light source 120d are located on the other side and share a second photosensitive element 162. A photosensitive element generates a detection signal accordingly after receiving a light beam. As shown in FIG. 5, since the arrangement direction of the first sub-light source 110a and the first sub-light source 110b is parallel to the axial direction of the deflection device 150, in the plan view of FIG. 3, the first sub-light source 110a and the first sub-light source 110b overlap at the same position, so that the first sub-beam 101a emitted by the first sub-light source 110a and the first sub-beam 101b emitted by the first sub-light source 110b overlap in the plan view. At this moment, the first sub-beam 101a and the first sub-beam 101b will be synchronously deflected after being rotationally deflected by the deflection device, and will be sensed by the first photosensitive element 161 at the same time, so the first photosensitive element 161 merely generates one first detection signal. Similarly, since the second sub-light source 120c and the second sub-light source 120d overlap at the same position, the second sub-beam 102c emitted by the second sub-light source 120c and the second sub-beam 102d emitted by the second sub-light source 120d overlap in the plan view of FIG. 3. The second sub-beam 102c and the second sub-beam 102d rotated and deflected by the deflection device will be sensed by the second photosensitive element 162 at the same time, so the second photosensitive element 162 merely generates one second detection signal. This means that during the deflection process of the deflection device 150, even if the same side includes multiple light beams, since the light beams on the same side overlap in the axial direction of the deflection device 150, i.e., the y-axis direction, and correspond to one photosensitive element, the controller has a unified control timing for the light beams on the same side. That is, the control timings of the light beams L1 and L2 are unified, both start scanning based on the first detection signal of the first photosensitive element 161, and the control timings of the light beams L3 and L4 are unified, both start scanning based on the second detection signal of the second photosensitive element 162. Due to differences in design positions and installation errors, the moments when the light beams L1 and L2 respectively arrive at the scanning start points of the first photosensitive member 211a and the first photosensitive member 211b after the first detection signal is triggered may be the same or different. Therefore, the first time intervals corresponding to the light beams L1 and L2 may be set to be the same or different according to actual conditions. Similarly, the second time intervals corresponding to the light beams L3 and L4 may be set to be the same or different according to actual conditions. Therefore, in order to ensure the color superposition accuracy of the final image during the laser scanning process, it is merely essential to ensure that the control timings of the light beams on both sides of the laser scanning unit 100 are synchronized based on the first detection signal and the second detection signal.

In the embodiments of the present disclosure, when the deflection device 150 rotates in a fixed direction, such as clockwise as shown in FIG. 3, the first photosensitive element 161 generates a corresponding first detection signal after receiving the light beam L5 deflected by the deflection device 150. After receiving the first detection signal, the controller controls the positions of the scanning start points of the light beams L1 and L2 on the corresponding first photosensitive member according to the first detection signal, and controls the light beams L1 and L2 to scan the surface of the corresponding first photosensitive member from the negative pole of the z-axis to the positive pole of the z-axis. The second photosensitive element 162 generates a corresponding second detection signal after receiving the light beam L6 deflected by the deflection device 150. After receiving the second detection signal, the controller controls the positions of the scanning start points of the light beams L3 and L4 on the corresponding second photosensitive member according to the second detection signal, and controls the light beams L3 and L4 to scan the surface of the corresponding second photosensitive member from the positive pole of the z-axis to the negative pole of the z-axis. Therefore, by controlling the synchronization of the first detection signal and the second detection signal, the control timing synchronization of the light beams on both sides of the laser scanning unit 100 may be ensured.

FIG. 6 is a schematic diagram of the exposure control timing of a laser scanning unit, in accordance with an embodiment of the present disclosure. As shown in FIG. 6, after receiving the light beam L5, the first photosensitive element 161 generates a first detection signal Hsync 1. After a first time interval T1, the control center of the image forming device uses the light beam L1 of the first sub-light source to expose the image image1 through the control signal Data1, and uses the light beam L2 of the second sub-light source to expose the image image2 through the control signal Data2. After receiving the light beam L6, the second photosensitive element 162 generates a second detection signal Hsync2. After a second time interval T2, the control center of the image forming device uses the light beam L3 to expose the image image3 through the control signal Data3, and uses the light beam L4 to expose the image image4 through the control signal Data4.

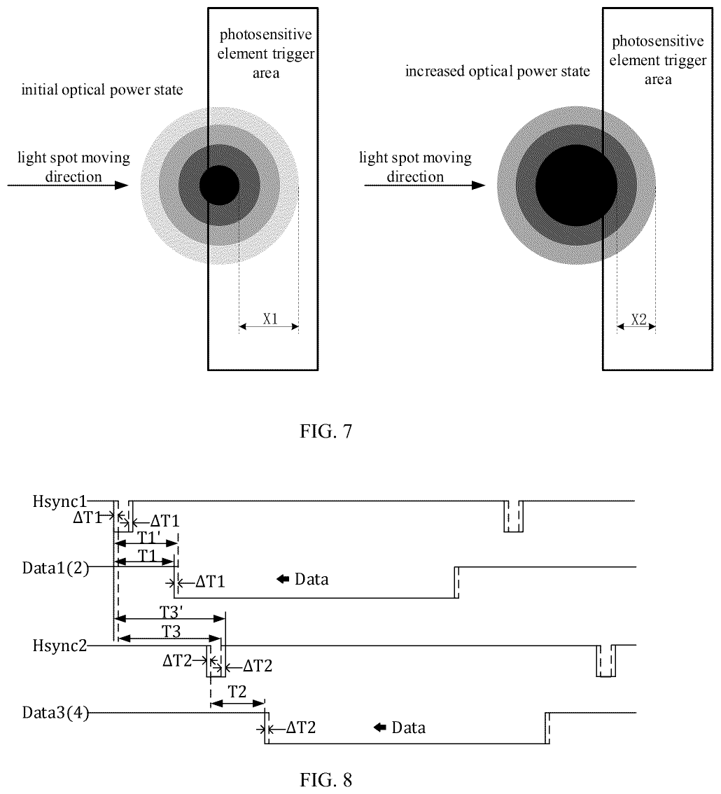

Under normal circumstances, images image1, image2, image3 and image4 are aligned in the main scanning direction, that is, the image overlay accuracy is high and the image quality is good. However, during the image formation process, as factors such as the image formation environment and the image formation medium change, the density and color of the image will change, affecting the quality of the image. For example, under the influence of ambient temperature, the output optical power of the laser scanning unit will change, thereby causing the output light intensity of the laser scanning unit to change accordingly. As shown in FIG. 7, the left view and the right view are the corresponding light spot positions when the light beam emitted by the light source causes the photosensitive element to generate a detection signal in the initial optical power state and the state where the optical power is enhanced due to the influence of the external environment. In the initial optical power state, the light intensity level is normal, and the light intensity of the light beam gradually decreases from the center point to the outside. Therefore, the light spot of the light beam may be divided into a plurality of concentric continuous circular areas according to the light intensity. In this case, the light beam needs to reach a certain light intensity to trigger the photosensitive element, such as the central black area of the light spot in the left figure. At this moment, when the light spot starts to reach the photosensitive element triggering area from the outermost circle, it continues to move along the moving direction of the light spot. After a distance X1, the area where the black aperture is located may trigger the photosensitive element so that the photosensitive element generates a detection signal. When the light spot continues to move so that the black aperture leaves the photosensitive element, the photosensitive element no longer generates a detection signal. Therefore, in combination with FIG. 6, it may be obtained that the falling edge of the first detection signal Hsync1 corresponds to the moment when the black aperture contacts the triggering area of the photosensitive element, and the rising edge of the first detection signal Hsync1 corresponds to the moment when the black aperture leaves the triggering area of the photosensitive element. When the light power is increased, when the light spot starts to reach the triggering area of the photosensitive element from the outermost circle, it continues to move along the moving direction of the light spot. After a distance X2, the area where the black aperture is located triggers the photosensitive element and causes the photosensitive element to generate a detection signal. Since X1>X2 and since the range of the black aperture is expanded compared to the initial light power state, it may be determined that the light spot position corresponding to the photosensitive element generating the detection signal is advanced (i.e., move beforehand) compared to the initial light power state and the triggering time of the corresponding detection signal becomes longer. That is, when the light power is increased, the light spot will trigger the first photosensitive element 161 and the second photosensitive element 162 earlier and generate a detection signal.

It should be noted that Data1(2) shown in FIG. 6 indicates that the control signal Data1 and the control signal Data2 are essentially the same, and this explanation also applies to serial numbers such as Data3(4) shown in the same manner.

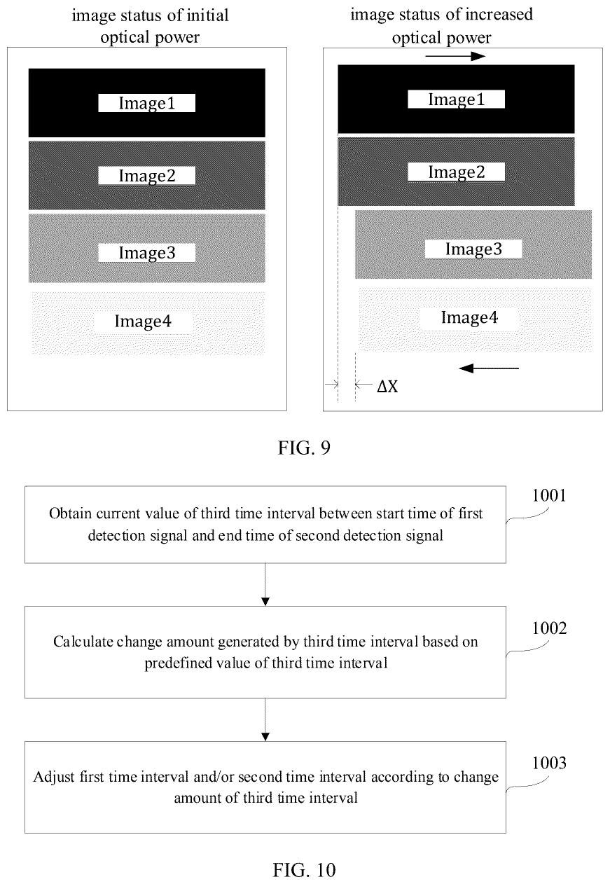

FIG. 8 is a schematic diagram of the exposure control timing of a laser scanning unit after light power increase, in accordance with an embodiment of the present disclosure. As shown in FIG. 8 and combined with FIG. 7, after the light power is increased, the pulse widths of the first detection signal Hsync1 and the second detection signal Hsync2 will increase approximately symmetrically by 2*ΔT1 and 2*ΔT2 respectively. Since the reference of the first detection signal and the second detection signal is the point where the pulse starts, it is equivalent to the reference line of the first detection signal Hsync1 being advanced by ΔT1, and the reference line of the second detection signal Hsync2 being advanced by ΔT2. In addition, since the image forming device sets the time interval from the first detection signal Hsync1 to the exposure start time (first image data scanning start time) to be fixed T1, and the time interval from the second detection signal Hsync2 to the exposure start time (second image data scanning start time) to be fixed T2, the exposure start time of the photosensitive assembly 210a and the photosensitive assembly 210b will be advanced by ΔT1, respectively, thereby causing the scanning start positions of the light beam L1 and the light beam L2 on the corresponding first photosensitive member 211a and the second photosensitive member 211b to be advanced, causing the corresponding image on the photosensitive member to be offset, as shown in FIG. 9. In addition, since the scanning directions of the light beams L1 and L2 are opposite to those of the light beams L3 and L4, the images image1 and image2 and the images image3 and image4 will eventually move in the opposite direction, as shown in FIG. 9, causing the images to be displaced ΔX in the main scanning direction, and eventually causing the color overlap to deteriorate, affecting the image quality. Similarly, when the light power is reduced, the image will be displaced in the opposite direction, which will also cause the color overlap to deteriorate, affecting the image quality.

In view of this problem, the control method of the controller is improved in the embodiments of the present disclosure.

FIG. 10 is a flow chart of a scanning control method, in accordance with an embodiment of the present disclosure. The method may be applied to the controller of the laser scanning unit shown in FIGS. 1 to 5. As shown in FIG. 10, the method mainly includes the following steps:

S1001: Obtain a current value of a third time interval between a start time of a first detection signal and an end time of a second detection signal.

The difference between the start time of the first detection signal and the end time of the second detection signal is calculated to obtain the current value T3′ of the third time interval.

In the embodiments of the present disclosure, as shown in FIG. 8, when the optical power increases, the pulse start time of the first detection signal Hsync1 will be advanced, and the pulse end time of the second detection signal Hsync2 will be delayed. Similarly, when the optical power decreases, the pulse start time of the first detection signal Hsync1 will be delayed, and the pulse end time of the second detection signal Hsync2 will be advanced. Therefore, the image forming device may monitor the pulse start time of the first detection signal Hsync1 and the pulse end time of the second detection signal Hsync2 before each image forming operation, and obtain the current value T3′ of the third time interval based on the difference between the pulse start time of the first detection signal Hsync1 and the pulse end time of the second detection signal Hsync2. In one embodiment, whether the optical power increases or decreases, the pulse end time of the second detection signal Hsync2 is generally later than the pulse start time of the first detection signal Hsync1. Therefore, the current value T3′ of the third time interval is generally equal to the pulse end time of the second detection signal Hsync2 minus the pulse start time of the first detection signal Hsync.

S1002: Calculate a change value generated by the third time interval based on a predefined value of the third time interval.

If the current value T3′ of the third time interval does not match the predefined value T3 of the third time interval, a difference is calculated between the current value T3′ of the third time interval and the predefined value T3 of the third time interval to obtain a change value ΔT3 of the third time interval.

In the embodiments of the present disclosure, a predefined value T3 of the third time interval is pre-stored. The predefined value T3 of the third time interval may be a fixed value or a current value of the third time interval calculated in the previous round of image forming operation. When the current value T3′ of the third time interval in this image forming operation is obtained, the current value T3′ of the third time interval may be compared with the predefined value T3 of the third time interval. If the current value T3′ of the third time interval does not match the predefined value T3 of the third time interval, it proves that the optical power has changed. At this moment, the difference between the current value T3′ of the third time interval and the predefined value T3 of the third time interval is calculated to obtain the change value ΔT3 of the third time interval, that is, ΔT3=T3′-T3.

In one embodiment, when the optical power increases, the current value T3′ of the third time interval is greater than the predefined value T3 of the third time interval, and the obtained change value ΔT3 of the third time interval is a positive value. When the optical power decreases, the current value T3′ of the third time interval is less than the predefined value T3 of the third time interval, and the obtained change value ΔT3 of the third time interval is a negative value.

S1003: Adjust the first time interval and/or the second time interval according to the change value of the third time interval.

In the embodiments of the present disclosure, when the optical power changes, in order to ensure the alignment of the image formed after scanning, it is essential to adjust the moment of the scanning start point on the first photosensitive members 211a and 211b and the second photosensitive members 211c and 211d, that is, adjust the position of the scanning start point. Specifically, the position of the scanning start point may be adjusted by adjusting the first time interval, such as adjusting the first time interval from the original T1 to T1′, and/or adjusting the second time interval, such as adjusting the second time interval from the original T2 to T2′. Here, T1 is a predefined value of the first time interval, which may be a fixed value or a current value of the first time interval obtained in the previous round of image forming operation (when the predefined value of the third time interval is adjusted in the previous round, T1 is the current value in the previous round of image forming operation), and T1′ is the current value of the first time interval in the current round of image forming operation. T2 is the predefined value of the second time interval, which may be a fixed value or the current value of the second time interval obtained in the previous round of image forming operation (when the predefined value of the third time interval is adjusted in the previous round, T2 is the current value in the previous round of image forming operation), and T2′ is the current value of the second time interval in this round of image forming operation.

However, in practical applications, when the optical power changes, it is not possible to calculate the pulse advance of the first detection signal Hsync1 and the second detection signal Hsync2 according to the detection of the pulse start time of the first detection signal Hsync1 and the second detection signal Hsync2, nor is it possible to obtain the pulse change of the first detection signal Hsync1 and the second detection signal Hsync2 according to the difference between the pulse start time and the pulse end time of the first detection signal Hsync1 and the second detection signal Hsync2. Therefore, it is not possible to adjust the first time interval and/or the second time interval according to the specific advance amount or change value, so as to adjust the position of the scanning start point on the first photosensitive member 211a, 211b and the second photosensitive member 211c, 211d. However, it may be found from FIG. 8 that the third time interval between the pulse start time of the first detection signal Hsync1 and the pulse end time of the second detection signal Hsync2 may be accurately detected and used for calculating the total pulse advance amount. Specifically, the total pulse advance amount of the first detection signal Hsync1 and the second detection signal Hsync2 may be obtained by detecting the change value in the time interval between the pulse start time of the first detection signal Hsync1 and the pulse end time of the second detection signal Hsync2, that is, the change value in the third time interval ΔT3, so as to adjust the first time interval and/or the second time interval according to the total pulse advance amount to ensure the color superposition accuracy of the image.

It should be noted that the total pulse advance amount refers to the sum of the pulse advance amount of the first detection signal Hsync1 and the pulse advance amount of the second detection signal Hsync2.

As shown in FIG. 8, the pulse advance amount of the first detection signal Hsync1 is ΔT1, and the pulse advance amount of the second detection signal Hsync2 is ΔT2. Therefore, the total pulse advance amount=ΔT1+ΔT2=the change value ΔT3 of the third time interval.

In one embodiment, adjusting the first time interval and the second time interval according to the total pulse advance amount includes: setting a first difference ΔT1′ and a second difference ΔT2′ according to a change value ΔT3 of the third time interval, adjusting the first time interval based on the first difference ΔT1′ so that the adjusted first time interval is equal to the sum of a predefined value T1 of the first time interval and the first difference ΔT1′, which makes the current value of the first time interval T1′=T1+ΔT1′; and adjusting the second time interval based on the second difference ΔT2′ so that the adjusted second time interval is equal to the sum of a predefined value T2 of the second time interval and the second difference ΔT2′, which makes the current value of the second time interval T2′=T2+ΔT2′.

In one embodiment, setting the first difference ΔT1′ and the second difference ΔT2′ according to the change value ΔT3 of the third time interval includes: setting the first difference ΔT1′ and the second difference ΔT2′ according to the formula ΔT1′+ΔT2′=ΔT3, that is, when setting ΔT1′ and ΔT2′, it is essential to ensure that the sum of ΔT1′ and ΔT2′ is equal to ΔT3.

In one embodiment, merely the first time interval or the second time interval may be adjusted according to the total pulse advance amount, specifically including: setting a first difference ΔT1′ according to the change value ΔT3 of the third time interval, and adjusting the first time interval based on the first difference ΔT1′, so that the adjusted first time interval is equal to the sum of the predefined value T1 of the first time interval and the first difference ΔT1′. The second difference is 0 at this time, that is, the second time interval is not adjusted.

Alternatively, the second difference ΔT2′ is set according to the change value ΔT3 of the third time interval, and the second time interval is adjusted based on the second difference ΔT2′, so that the adjusted second time interval is equal to the sum of the predefined value T2 of the second time interval and the second difference ΔT2′. At this moment, the first difference is 0, that is, the first time interval is not adjusted.

In one embodiment, setting the first difference ΔT1′ according to the change value ΔT3 of the third time interval includes: setting the first difference ΔT1′ according to the formula ΔT1′=ΔT3.

In one embodiment, setting the second difference ΔT2′ according to the change value ΔT3 of the third time interval includes: setting the second difference ΔT2′ according to the formula ΔT2′=ΔT3.

In the embodiments of the present disclosure, the adjustment amount of the first time interval and/or the adjustment amount of the second time interval are set according to the change value ΔT3 of the third time interval, so that the current value T1′ of the adjusted first time interval and the current value T2′ of the second time interval finally meet the condition: T1′+T2′=T1+T2+ΔT3. At this moment, since the scanning width of each photosensitive member in the axial direction is consistent, the scanning start position of the first photosensitive member 211a, 211b is aligned with the scanning end position on the second photosensitive member 211c, 211d, and the scanning start position of the second photosensitive member 211c, 211d is aligned with the scanning end position on the first photosensitive member 211a, 211b, which is the same as the initial light power state, so that accurate color superposition is achieved and the image quality is not affected. It should be noted that the above equation is mainly to ensure that the scanning area of the photosensitive members on all imaging cartridges is consistent, and to ensure that the images transferred by each photosensitive member are aligned on the image area on the transfer belt. Exemplarily, as shown in FIGS. 8 and 9, when the first detection signal Hsync1 pulse is advanced by ΔT1, the corresponding images image1 and image2 move to the left by a distance ΔX1 corresponding to ΔT1. When the second detection signal Hsync2 pulse is advanced by ΔT2, the corresponding images image3 and image4 move to the right by a distance ΔX2 corresponding to ΔT2. In this case, a difference of ΔX (AX=ΔX1+ΔX2) will appear between the images image 1, image2 and the images image3, image4, and a color overlap deviation will occur between the images, affecting the final imaging quality. In this case, the first time interval and/or the second time interval is adjusted according to the equation ΔT1′+ΔT2′=ΔT3. That is, when adjusting the first time interval and/or the second time interval, the current value T1′ of the first time interval is increased by ΔT1′ relative to the predefined value T1 of the first time interval, and the current value T2′ of the second time interval is increased by ΔT2′ relative to the predefined value T2 of the second time interval, so that aligned images image 1, image2, image3 and image4 may be obtained.

From the above analysis, it can be seen that since ΔT1′ and ΔT2′ are unknown in actual applications, but ΔT3 may be obtained through timing calculation, when adjusting the first time interval and/or the second time interval, it is merely essential to ensure that the sum of ΔT1′ and ΔT2′ is equal to ΔT3, and the embodiments of the present disclosure do not make specific requirements for the values of ΔT1′ and ΔT2′. Exemplarily, when the color stacking deviation is generated due to the change of light power, if the calculated ΔT3=2, assume ΔT1′=0, ΔT2′=2, referring to the right view in FIG. 9, that is, the image image1 and the image image2 remain stationary, and the image image3 and the image image4 move to the left by the moving distance ΔX corresponding to ΔT3 to align with the image image1 and the image image2, thereby eliminating the color stacking deviation. Alternatively, assume ΔT1′=1, ΔT2′=1, that is, the image image1 and the image image2 move to the right by the distance ΔX1 corresponding to ΔT1′, and the image image3 and the image image4 move to the left by the distance ΔX2 corresponding to ΔT2′, then the color stacking deviation may be eliminated. In one embodiment, ΔT1′ or ΔT2′ may also be negative numbers, as long as ΔT1′+ΔT2′=ΔT3 is satisfied.

It should be noted that, in actual applications, due to the manufacturing and installation accuracy of each component in an image forming device, the ΔT1′ and ΔT2′ calculated theoretically in the above steps are different from the actual use. Therefore, before the image forming device leaves the factory, the theoretically obtained ΔT1′ and ΔT2′ under different light powers may be tested with the actually required ΔT1′ and ΔT2′, and the error values under each light power may be calculated and stored in the image forming device. In actual applications, the theoretically obtained ΔT1′ and ΔT2′ may be adjusted accordingly according to the stored error values to obtain ΔT1′ and ΔT2′ that meet the actual situations. In the present disclosure, when the first time interval and/or the second time interval are adjusted according to the change value of the third time interval during the scanning control process, the positive and negative values of the change value of the third time interval determine whether the image has a positive offset or a negative offset, and the corresponding first time interval and second time interval are adjusted according to the positive offset or the negative offset so that the first image(s) formed by the first photosensitive member and the second image(s) formed by the second photosensitive member are aligned along the image transfer direction of the transfer unit.

Specifically, when the change value in the third time interval is positive, it indicates that the first image and the second image have a positive offset phenomenon. As shown in FIGS. 8 and 9, under the positive offset phenomenon, the optical power is enhanced, and the corresponding pulse widths of the first detection signal and the second detection signal are increased. At this moment, the position of the first image on the transfer belt is positively offset to the left compared to the position of the second image on the transfer belt, and the position of the second image on the transfer belt is reversely offset to the right compared to the position of the first image on the transfer belt. Thus, the first time interval and the second time interval are adjusted to eliminate the positive deviation between the two images. In this case, ensuring that the sum of the adjustment amount of the first time interval and the adjustment amount of the second time interval is a positive value may ensure that the first image and the second image move in corresponding directions to overcome the positive offset phenomenon. Similarly, when the change in the third time interval is negative, it indicates that a negative offset phenomenon occurs in the first image and the second image. Under the negative offset phenomenon, the optical power is weakened, and the pulse widths of the corresponding first detection signal and the second detection signal are narrowed. At this moment, the position of the first image on the transfer belt is reversely offset to the right compared to the position of the second image on the transfer belt, and the position of the second image on the transfer belt is positively offset to the left compared to the position of the first image on the transfer belt. Therefore, the first time interval and the second time interval are adjusted to eliminate the negative offset between the two images. In this case, ensuring that the sum of the adjustment amount of the first time interval and the adjustment amount of the second time interval is a negative value may ensure that the first image and the second image move in the corresponding directions to overcome the negative offset phenomenon.

It may be understood that, in the embodiments of the present disclosure, when the first light source includes N first sub-light sources, since the first time intervals corresponding to the N first sub-light sources may be the same or different, but are all executed based on the first detection signal, and since the deflection speed of the deflection device is fixed, the speed at which the light beam is deflected by the deflection device is also fixed, and thus the scanning movement amount of the first sub-light beam on the first photosensitive member is the same within the same time period. Therefore, the first time intervals corresponding to the N first sub-light sources are adjusted simultaneously based on the same adjustment amount, so that the offset amounts of the first images formed by each first photosensitive member at the same and different first time intervals may be ensured to be the same, thereby performing synchronous calibration on the image offset of each first photosensitive member. When the second light source includes M second sub-light sources, the second time intervals corresponding to the M second sub-light sources may be the same or different, but are all executed based on the second detection signal, and the deflection speed of the deflection device is fixed, so the speed at which the light beam is deflected by the deflection device is also fixed. Therefore, the scanning movement amount of the second sub-light beam on the second photosensitive member is the same within the same time period. Therefore, the second time intervals corresponding to the M second sub-light sources are adjusted simultaneously based on the same adjustment amount, so as to ensure that the offset of the second image formed by each second photosensitive member at the same and different first time intervals is the same, thereby performing synchronous calibration on the image offset of each second photosensitive member.

In one embodiment, after the adjustment of the first time interval and/or the second time interval is completed, the predefined value T1 of the first time interval, the predefined value T2 of the second time interval, and the predefined value T3 of the third time interval may be updated to the current value T1′ of the first time interval, the current value T2′ of the second time interval, and the current value T3′ of the third time interval, respectively.

In one embodiment of the present disclosure, steps S1001 to S1003 are preparatory work before performing an image forming operation. To ensure the accuracy of image color overlay, the image forming device may adjust the first time interval and/or the second time interval according to steps S1001 to S1003 before each image forming operation, and perform the image forming operation based on the adjusted first time interval and second time interval.

In the embodiments of the present disclosure, when the optical power changes, the first time interval and/or the second time interval is adjusted by the change value in the time interval between the start time of the first detection signal Hsync1 and the end time of the second detection signal Hsync2, that is, the change value in the third time interval ΔT3, thereby adjusting the start scanning position of the first light beam on the first photosensitive member and/or adjusting the start scanning position of the second light beam on the second photosensitive member. This then ensures that the color superposition accuracy of the image remains unchanged and meets the image quality requirements.

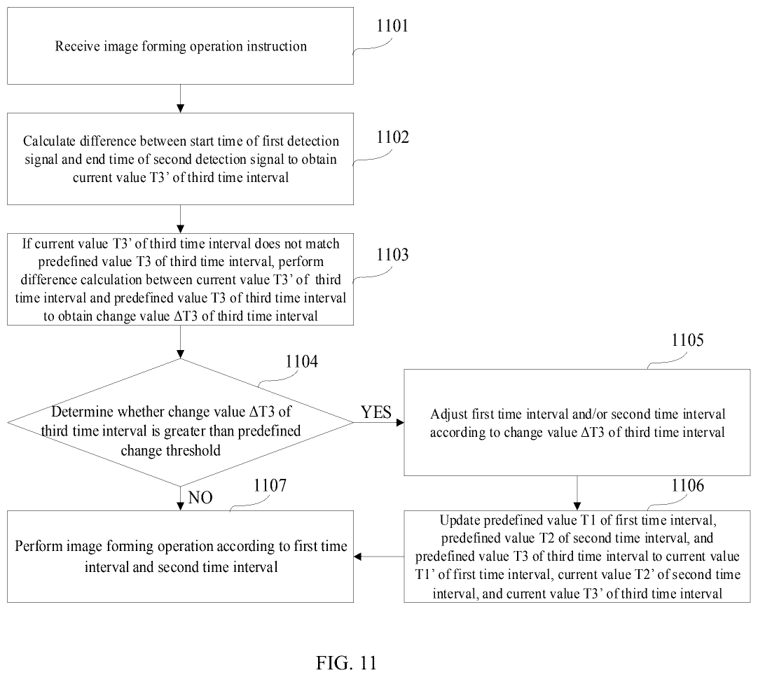

FIG. 11 is a flow chart of another scanning control method, in accordance with an embodiment of the present disclosure. The control method specifically includes:

S1101: Receive an image forming operation instruction.

After receiving the image forming operation instruction, the laser scanning unit starts to perform the preparatory work before the image forming operation as shown in Steps S1102 to S1107.

S1102: Calculate the difference between the start time of the first detection signal and the end time of the second detection signal to obtain a current value T3′ of the third time interval.

The specific content of this step may refer to Step S1001. For the sake of brevity, the embodiments of the present disclosure will not be described in detail here.

S1103: If the current value T3′ of the third time interval does not match the predefined value T3 of the third time interval, perform a difference calculation between the current value T3′ of the third time interval and the predefined value T3 of the third time interval to obtain a change value ΔT3 of the third time interval.

The specific content of this step may refer to Step S1002. For the sake of brevity, the embodiments of the present disclosure will not be described in detail here.

S1104: Determine whether the change value ΔT3 of the third time interval is greater than a predefined change threshold.

The change threshold may be set according to the required image quality. Generally, the higher the tolerance of the image quality, the smaller the change threshold. When the change value ΔT3 of the third time interval is greater than the predefined change threshold, proceed to Step S1105. When the third difference ΔT3 is less than or equal to the predefined change threshold, proceed to Step S1107.

It should be noted that in the embodiments of the present disclosure, the change threshold is not an accurate value that may be obtained at the beginning, but is continuously iterated and updated according to the requirements of image quality in actual applications to eventually obtain the required change threshold.

S1105: Adjust the first time interval and/or the second time interval according to the change value ΔT3 of the third time interval.

The specific content of this step may refer to Step S1003, and for the sake of brevity, the embodiments of the present disclosure will not be described in detail here.

S1106: Update the predefined value T1 of the first time interval, the predefined value T2 of the second time interval, and the predefined value T3 of the third time interval to the current value T1′ of the first time interval, the current value T2′ of the second time interval, and the current value T3′ of the third time interval.

Due to the continuity of environmental changes, the optical power changes are also continuous. The predefined value T1 of the first time interval, the predefined value T2 of the second time interval and the predefined value T3 of the third time interval are updated to the current value T1′ of the first time interval, the current value T2′ of the second time interval and the current value T3′ of the third time interval for storage. This may reduce the change of the change value ΔT3 of the third time interval in the next round of image formation process, thereby reducing the number of times the first time interval and the second time interval are adjusted.

S1107: Perform the image forming operation according to the first time interval and the second time interval.

The controller controls the first scanning start time according to the updated first time interval T1, and controls the second scanning start time according to the updated second time interval T2.

The embodiments of the present disclosure set a change threshold according to the allowable difference in image quality, so that even if the third difference (i.e., the change value ΔT3 of the third time interval) reaches the change threshold, the laser scanning unit does not adjust the first time interval and the second time interval, and the image overlay may still meet the image quality specifications. The number of times the first time interval and the second time interval are adjusted may be reduced, and the preparation time for image formation operations may be shortened.

Corresponding to the above embodiments, the embodiments of the present disclosure further provide another laser scanning unit, which includes the structure shown in the embodiments of FIGS. 1 to 5, and uses the methods shown in the embodiments of FIGS. 10 to 11 to control image formation. Different from FIGS. 1 to 5, the laser scanning unit does not include a controller, that is, the controller and the laser scanning unit are set independently of each other.

Except that the controller and the laser scanning unit are independently arranged in the embodiments of the present disclosure, other specific contents may be found in the description of the above structure and method embodiments. For the sake of brevity, the details will not be repeated here.

Corresponding to the above embodiments, the embodiments of the present disclosure also provide another image forming device.

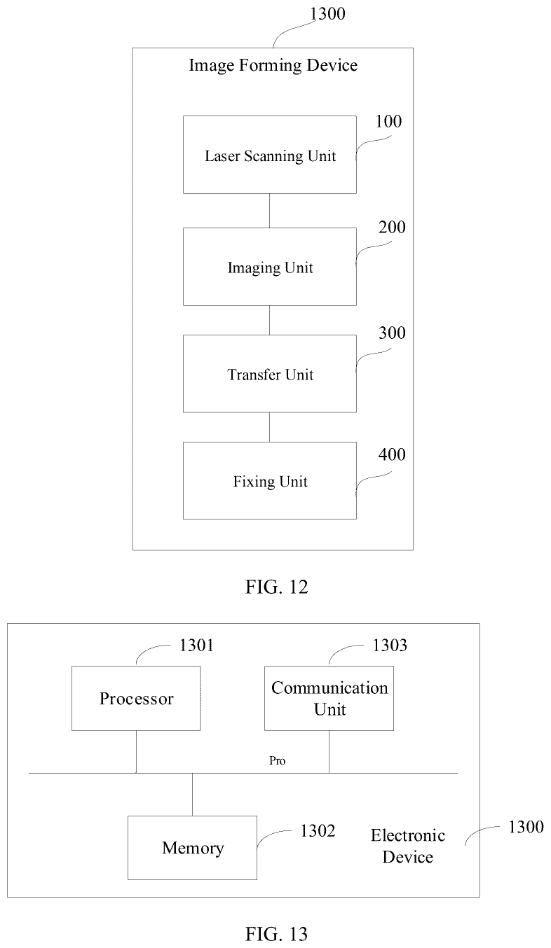

FIG. 12 is a schematic structural diagram of another image forming device, in accordance with an embodiment of the present disclosure. As shown in FIG. 12, the image forming device 1200 may include a laser scanning unit 100, an imaging unit 200, a transfer unit 300, and a fixing unit 400, where the laser scanning unit 100 does not include a controller. That is, the controller and the laser scanning unit 100 are independently arranged.

In the embodiments of the present disclosure, except that the controller and the laser scanning unit are independently arranged, other specific contents may refer to the description of the above structure and method embodiments. For the sake of brevity, these contents will not be repeated here.

Corresponding to the above embodiments, the present disclosure also provides an electronic device.

FIG. 13 is a schematic structural diagram of an electronic device, in accordance with an embodiment of the present disclosure. The electronic device 1300 may include a processor 1301, a memory 1302, and a communication unit 1303. These components communicate via one or more buses, and those skilled in the art may understand that the structure of the electronic device shown in the figure does not constitute a limitation on the embodiments of the present disclosure. The electronic device may be a bus structure or a star structure, and may also include more or fewer components than those shown in the figure, or combine certain components, or arrange the components differently.

The communication unit 1303 is configured to establish a communication channel so that the electronic device may communicate with other devices, receive user data sent by other devices or send user data to other devices, etc.

The processor 1301 is the control center of the electronic device. The processor uses various interfaces and lines to connect various parts of the entire electronic device. The processor runs or executes software programs, instructions, and/or modules stored in the memory 802, and calls data stored in the memory to perform various functions of the electronic device and/or process data. The processor may be composed of an integrated circuit (IC), for example, the processor may be composed of a single packaged IC, or multiple packaged ICs with the same or different functions. For example, the processor 1301 may include merely a central processing unit (CPU). In the embodiments of the present disclosure, the CPU may be a single computing core or multiple computing cores.

The memory 1302 is configured to store the execution instructions of the processor 1301. The memory 1302 may be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

When the execution instructions in the memory 1302 are executed by the processor 1301, the electronic device 1300 is enabled to execute part or all of the steps in the illustrated embodiments in FIGS. 10-11.

In one embodiment, the present disclosure further provides a computer storage medium, where the computer storage medium may store a program, and when the program is executed, the program may include some or all of the steps in each embodiment of the scanning control method provided by the present disclosure. The storage medium may be a magnetic disk, an optical disk, a read-only memory (ROM) or a random access memory (RAM), etc.

In one embodiment, the present disclosure further provides a computer program product, where the computer program product includes executable instructions, and when the executable instructions are executed on a computer, the computer executes part or all of the steps in each embodiment of the scanning control method provided by the present disclosure.

Those skilled in the art may clearly understand that the technology in the embodiments of the present disclosure may be implemented by means of software plus a necessary general hardware platform. Based on this understanding, the technical solution in the embodiments of the present disclosure is essentially or the part that contributes to the existing technologies may be embodied in the form of a software product, which may be stored in a storage medium such as ROM/RAM, a magnetic disk, an optical disk, etc., and includes a number of instructions for a computer device (which may be a personal computer, a server, or a network device, etc.) to execute the methods described in the various embodiments or some parts of the embodiments of the present disclosure.

In this specification, the same or similar parts between the various embodiments may refer to each other. In particular, for the device embodiments and the terminal embodiments, since they are basically similar to the method embodiments, the description is relatively simple, and the relevant parts may refer to the description in the method embodiments.

What is claimed is:

1. A laser scanning unit, applied to an image forming device, the image forming device including an imaging unit for forming an image and a transfer unit for transferring the image to a recording material, the imaging unit including a first imaging cartridge and a second imaging cartridge, the first imaging cartridge having a first photosensitive member arranged perpendicularly to an image transfer direction of the transfer unit, the second imaging cartridge having a second photosensitive member arranged perpendicularly to the image transfer direction of the transfer unit, and the laser scanning unit comprising:
a deflection device for rotating and deflecting a light beam;
an optical system for transmitting the light beam deflected by the deflection device to the imaging unit;
a first light source, configured to emit a first light beam, wherein the first light beam is rotated and deflected by the deflection device to the optical system, and then transmitted to the first photosensitive member through the optical system, and scans a surface of the first photosensitive member along a first direction as the deflection device rotates;
a second light source, configured to emit a second light beam, wherein the second light beam is rotated and deflected by the deflection device to the optical system, and then transmitted to the second photosensitive member through the optical system, and scans a surface of the second photosensitive member along a second direction as the deflection device rotates, and the second direction is opposite to the first direction;
a line synchronization detection unit, including a first photosensitive element and a second photosensitive element, wherein the first photosensitive element is configured to sense the first light beam rotationally deflected by the deflection device and generate a first detection signal, and the second photosensitive element is configured to sense the second light beam rotationally deflected by the deflection device and generate a second detection signal; and
a controller, configured to adjust a first time interval and/or a second time interval according to a change value of a third time interval, wherein:
the change value of the third time interval is determined by a current value of the third time interval and a predefined value of the third time interval;
the first time interval is an interval between a start time of the first detection signal and a first scanning start time, the second time interval is an interval between a start time of the second detection signal and a second scanning start time, and the third time interval is an interval between the start time of the first detection signal and an end time of the second detection signal; and
the first light source is configured to start emitting the first light beam to scan the first photosensitive member based on the first scanning start time, and the second light source is configured to start emitting the second light beam to scan the second photosensitive member based on the second scanning start time.

2. The laser scanning unit according to claim 1, wherein adjusting the first time interval and/or the second time interval according to the change value of the third time interval comprises:
setting a first difference and a second difference based on the change value;
adjusting the first time interval based on the first difference, wherein the adjusted first time interval is equal to a sum of a predefined value of the first time interval and the first difference; and
adjusting the second time interval based on the second difference, and the adjusted second time interval is equal to a sum of a predefined value of the second time interval and the second difference.

3. The laser scanning unit according to claim 2, wherein setting the first difference and the second difference based on the change value of the third time interval comprises:
setting the first difference and the second difference based on the change value, wherein a sum of the first difference and the second difference is equal to the change value.

4. The laser scanning unit according to claim 1, wherein:
adjusting the first time interval according to the change value of the third time interval includes:
setting a first difference based on the change value; and
adjusting the first time interval based on the first difference, wherein the adjusted first time interval is equal to a sum of a predefined value of the first time interval and the first difference; or
adjusting the second time interval according to the change value of the third time interval includes:
setting a second difference based on the change value; and
adjusting the second time interval based on the second difference, wherein the adjusted second time interval is equal to a sum of a predefined value of the second time interval and the second difference.

5. The laser scanning unit according to claim 1, wherein adjusting the first time interval and/or the second time interval according to the change value of the third time interval comprises:
if the change value is greater than or equal to a predefined change threshold, adjusting the first time interval and/or the second time interval according to the change value of the third time interval.

6. The laser scanning unit according to claim 1, wherein the controller is further configured for:
after receiving the first detection signal generated by the first photosensitive element, delaying the first time interval, and then controlling the first light source to emit the first light beam to scan the first photosensitive member; and
after receiving the second detection signal generated by the second photosensitive element, delaying the second time interval, and then controlling the second light source to emit the second light beam to scan the second photosensitive member.

7. The laser scanning unit according to claim 1, wherein the first light source includes N first sub-light sources, each of which emits a first sub-light beam, and the imaging unit includes N first imaging cartridges, the N first sub-light beams are respectively configured to scan surfaces of first photosensitive members of the N first imaging cartridges along the first direction as the deflection device rotates, and adjustment amounts of first time intervals corresponding to the N first sub-light sources are the same, where N≥2.

8. The laser scanning unit according to claim 1, wherein the second light source includes M second sub-light sources, each of which emits a second sub-beam, the imaging unit includes M second imaging cartridges, the M second sub-beams are respectively configured to scan surfaces of second photosensitive members of the M second imaging cartridges along the second direction as the deflection device rotates, and adjustment amounts of second time intervals corresponding to the M second sub-light sources are the same, where M≥2.

9. The laser scanning unit according to claim 1, wherein the controller is further configured for:
after adjusting the first time interval and/or the second time interval according to the change value of the third time interval, updating the predefined value of the third time interval to the current value of the third time interval.

10. An image forming device, comprising a laser scanning unit, an imaging unit for forming an image, and a transfer unit for transferring the image to a recording material, the imaging unit including a first imaging cartridge and a second imaging cartridge, the first imaging cartridge having a first photosensitive member arranged perpendicularly to an image transfer direction of the transfer unit, the second imaging cartridge having a second photosensitive member arranged perpendicularly to the image transfer direction of the transfer unit, and the laser scanning unit comprising:
a deflection device for rotating and deflecting a light beam;
an optical system for transmitting the light beam deflected by the deflection device to the imaging unit;
a first light source, configured to emit a first light beam, wherein the first light beam is rotated and deflected by the deflection device to the optical system, and then transmitted to the first photosensitive member through the optical system, and scans a surface of the first photosensitive member along a first direction as the deflection device rotates;
a second light source, configured to emit a second light beam, wherein the second light beam is rotated and deflected by the deflection device to the optical system, and then transmitted to the second photosensitive member through the optical system, and scans a surface of the second photosensitive member along a second direction as the deflection device rotates, and the second direction is opposite to the first direction;
a line synchronization detection unit, including a first photosensitive element and a second photosensitive element, wherein the first photosensitive element is configured to sense the first light beam rotationally deflected by the deflection device and generate a first detection signal, and the second photosensitive element is configured to sense the second light beam rotationally deflected by the deflection device and generate a second detection signal; and
a controller, configured to adjust a first time interval and/or a second time interval according to a change value of a third time interval, wherein:
the change value of the third time interval is determined by a current value of the third time interval and a predefined value of the third time interval;
the first time interval is an interval between a start time of the first detection signal and a first scanning start time, the second time interval is an interval between a start time of the second detection signal and a second scanning start time, and the third time interval is an interval between the start time of the first detection signal and an end time of the second detection signal; and
the first light source is configured to start emitting the first light beam to scan the first photosensitive member based on the first scanning start time, and the second light source is configured to start emitting the second light beam to scan the second photosensitive member based on the second scanning start time.

11. The image forming device according to claim 10, wherein adjusting the first time interval and/or the second time interval according to the change value of the third time interval comprises:
setting a first difference and a second difference based on the change value;
adjusting the first time interval based on the first difference, wherein the adjusted first time interval is equal to a sum of a predefined value of the first time interval and the first difference; and
adjusting the second time interval based on the second difference, and the adjusted second time interval is equal to a sum of a predefined value of the second time interval and the second difference.

12. A scanning control method, applied to an image forming device, the image forming device including a laser scanning unit, an imaging unit for forming an image, and a transfer unit for transferring the image to a recording material, the imaging unit including a first imaging cartridge and a second imaging cartridge, the first imaging cartridge having a first photosensitive member arranged perpendicularly to an image transfer direction of the transfer unit, the second imaging cartridge having a second photosensitive member arranged perpendicularly to the image transfer direction of the transfer unit, and the laser scanning unit comprising:
a deflection device for rotating and deflecting a light beam;
an optical system for transmitting the light beam deflected by the deflection device to the imaging unit;
a first light source, configured to emit a first light beam, wherein the first light beam is rotated and deflected by the deflection device to the optical system, and then transmitted to the first photosensitive member through the optical system, and scans a surface of the first photosensitive member along a first direction as the deflection device rotates;
a second light source, configured to emit a second light beam, wherein the second light beam is rotated and deflected by the deflection device to the optical system, and then transmitted to the second photosensitive member through the optical system, and scans a surface of the second photosensitive member along a second direction as the deflection device rotates, and the second direction is opposite to the first direction; and
a line synchronization detection unit, including a first photosensitive element and a second photosensitive element, wherein the first photosensitive element is configured to sense the first light beam rotationally deflected by the deflection device and generate a first detection signal, and the second photosensitive element is configured to sense the second light beam rotationally deflected by the deflection device and generate a second detection signal,
wherein the scanning control method includes:
obtaining a current value of a third time interval between a start time of the first detection signal and an end time of the second detection signal;
calculating a change value generated by the third time interval based on a predefined value of the third time interval; and
adjusting a first time interval between a first scanning start time and a start time of the first detection signal and/or adjusting a second time interval between a second scanning start time and a start time of the second detection signal according to the change value,
wherein the first light source is configured to start emitting the first light beam to scan the first photosensitive member based on the first scanning start time, and the second light source is configured to start emitting the second light beam to scan the second photosensitive member based on the second scanning start time.

13. The method according to claim 12, wherein adjusting the first time interval and/or the second time interval according to the change value of the third time interval comprises:
setting a first difference and a second difference based on the change value;
adjusting the first time interval based on the first difference, wherein the adjusted first time interval is equal to a sum of a predefined value of the first time interval and the first difference; and
adjusting the second time interval based on the second difference, and the adjusted second time interval is equal to a sum of a predefined value of the second time interval and the second difference.

14. The method according to claim 13, wherein setting the first difference and the second difference based on the change value of the third time interval comprises:
setting the first difference and the second difference based on the change value, wherein a sum of the first difference and the second difference is equal to the change value.

15. The image forming device according to claim 12, wherein:
adjusting the first time interval according to the change value of the third time interval includes:
setting a first difference based on the change value; and
adjusting the first time interval based on the first difference, wherein the adjusted first time interval is equal to a sum of a predefined value of the first time interval and the first difference; or
adjusting the second time interval according to the change value of the third time interval includes:
setting a second difference based on the change value; and
adjusting the second time interval based on the second difference, wherein the adjusted second time interval is equal to a sum of a predefined value of the second time interval and the second difference.

16. The control method according to claim 12, wherein adjusting the first time interval and/or the second time interval according to the change value of the third time interval comprises:
if the change value is greater than or equal to a predefined change threshold, adjusting the first time interval and/or the second time interval according to the change value of the third time interval.

17. The method according to claim 12, wherein the control method further comprises:
after receiving the first detection signal generated by the first photosensitive element, delaying the first time interval, and then controlling the first light source to emit the first light beam to scan the first photosensitive member; and
after receiving the second detection signal generated by the second photosensitive element, delaying the second time interval, and then controlling the second light source to emit the second light beam to scan the second photosensitive member.

18. The method according to claim 12, wherein the first light source includes N first sub-light sources, each of which emits a first sub-light beam, and the imaging unit includes N first imaging cartridges, the N first sub-light beams are respectively configured to scan surfaces of first photosensitive members of the N first imaging cartridges along the first direction as the deflection device rotates, where N≥2; and
adjusting the first time interval and/or the second time interval according to the change value of the third time interval includes:
simultaneously adjusting first time intervals corresponding to the N first sub-light sources based on a same adjustment amount.

19. The method according to claim 12, wherein the second light source includes M second sub-light sources, each of which emits a second sub-light beam, the imaging unit includes M second imaging cartridges, and the M second sub-light beams are respectively configured to scan surfaces of second photosensitive members of the M second imaging cartridges along the second direction as the deflection device rotates, where M≥2; and
adjusting the first time interval and/or the second time interval according to the change value of the third time interval includes:
simultaneously adjusting second time intervals corresponding to the M second sub-light sources based on a same adjustment amount.

20. The method according to claim 12, further comprising:
after adjusting the first time interval and/or the second time interval according to the change value of the third time interval, updating the predefined value of the third time interval to the current value of the third time interval.
